(19) United States
(12) Patent Application Publication
(10) Pub. No.: US 2002/0178109 A1
(43) Pub. Date: Nov. 28, 2002

(54) Fact based negotiation tool

(76) Inventor: Jonathan Bye, Surrey (GB)

Correspondence Address: Timothy C. Meece, Banner & Witcoff, Ltd., Ten South Wacker Drive, Suite 3000, Chicago, IL, 60606-7407, US

(21) Appl. No.: 09/866,450

(22) Filed: May 25, 2001

(51) Int. Cl. G06F 17/60

(52) U.S. Cl. 705/37

(57) ABSTRACT

A method and system that allows a user to collect and review cost information for a number of different products from one or more possible suppliers of each product. According to some embodiments, the user sends a cost price breakdown sheet, tailored to a specific product, to one or more possible suppliers of a product. The cost price breakdown sheet can be prepared as a spreadsheet page (e.g., an Excel® spreadsheet page) and then electronically transmitted to each possible supplier via electronic mail, and each supplier completes and returns the cost price breakdown sheet. The cost information from each supplier can then be individually viewed, or viewed in combination with cost information from other suppliers. Further, the method and system may allow a buyer to graphically view cost information for better comprehension. Also, the method and system may allow a buyer to provide anticipated pricing information for each product and supplier combination, and then determine the profitability margin for the estimated sale of that product as provided by the supplier.

### BACKGROUND OF THE INVENTION

1. Field of the Invention

The present invention relates to a method and tool for compiling and comparing cost breakdown information across a supply base of products. The invention further provides a method and tool for determining margin information for different combinations of products, suppliers, and selling prices.

### DESCRIPTION OF THE PRIOR ART

Large retailers, such as department stores, discount stores, and Internet and catalog stores, will typically purchase and resell hundreds, if not thousands of different products. For example, a clothing retailer's “men's department” may sell four or more different models of overcoats alone (e.g., single-breasted, double-breasted, full-length, ¾ length, etc.). Moreover, each retailer will typically have a number of different suppliers who may provide one or more products. For example, a retailer may work with several suppliers who can each supply the retailer with a man's tan colored, full-length trench coat for resale as one of the possible models of overcoats.

Because of the large number of different products that may be sold by a retailer, it can be difficult for the personnel charged with making purchases for sales departments (conventionally referred to as “buyers”) to determine which combination of products from which suppliers will maximize the profitability of that department. The buyer must first obtain the different cost information for each product from the suppliers available to provide the product. The buyer must then compare the different costs of each product available for resale from each supplier, and the profitability margins that can be achieved from the sale of each product at its purchased price. Moreover, this information must be organized in a manner that can easily be comprehended and utilized by the buyer. Accordingly, there is a need for a trading tool that allows a buyer to conveniently collect product cost information from a variety of suppliers, and then present that cost information to the buyer in a useful format. Further, there is a need for a trading tool that can provide a buyer with margin information for products obtained at various costs from different suppliers.

### BRIEF SUMMARY OF THE INVENTION

Advantageously, the method and system provided by the Fact Based Negotiation Tool according to the invention allows a user to collect and review cost information for a number of different products from one or more possible suppliers of each product. According to some embodiments of the invention, the user employs the Fact Based Negotiation Tool to send a cost price breakdown sheet, tailored to reflect different costs associated with a specific product, to one or more possible suppliers of the product. With various embodiments of the invention, the cost price breakdown sheet can be prepared as a spreadsheet page (e.g., an Excel® spreadsheet page) and then electronically transmitted to the desired suppliers via electronic mail. After each supplier completes and returns the cost price breakdown sheet, the Fact Based Negotiation Tool imports the information from the sheet into a database.

Once imported into the database, the cost information from each supplier may conveniently be both individually viewed and viewed in combination with cost information from other suppliers. Also, cost information for different products, from one or more suppliers, can be simultaneously viewed. Thus, using the Fact Based Negotiation Tool, the buyer can compare and contrast both cost information for a number of different products from the same or different suppliers and cost information for the same product when provided by different suppliers. Further, some embodiments of the Fact Based Negotiation Tool allow a buyer to graphically view cost information for better comprehension.

In addition to collecting and displaying cost information for various product and supplier combinations, some embodiments of the Fact Based Negotiation Tool according to the invention allow a buyer to provide anticipated pricing information for each product and supplier combination. The Fact Based Negotiation Tool then determines the profitability margin for the estimated sale of that product using the cost information provided by the supplier for that product. Moreover, the buyer can compare the margin information for different product and supplier combinations, in order to determine which products, when provided by which suppliers, will maximize the profitability of the buyer's department. These and other features and advantages will become apparent from the following description, taken in light of the attached drawings.

### BRIEF DESCRIPTION OF THE DRAWINGS

FIG. 1 illustrates one example of a computer device that may be employed to implement various embodiments of the invention.

FIG. 2 is a block diagram showing the components of a Fact Based Negotiation Tool according to an embodiment of the invention.

FIG. 3 illustrates a graphic user interface according to an embodiment of the invention.

FIG. 4 shows a method of obtaining cost information for a product according to an embodiment of the invention.

FIGS. 5-8 illustrate graphic user interfaces according to an embodiment of the invention.

FIG. 9 shows one example of a cost price breakdown sheet according to an embodiment of the invention.

FIGS. 10-15 illustrate graphic user interfaces according to an embodiment of the invention.

FIGS. 16-18 illustrate information graphs provided by an embodiment of the invention.

FIG. 19 illustrates another graphic user interface according to an embodiment of the invention.

### DETAILED DESCRIPTION OF THE INVENTION

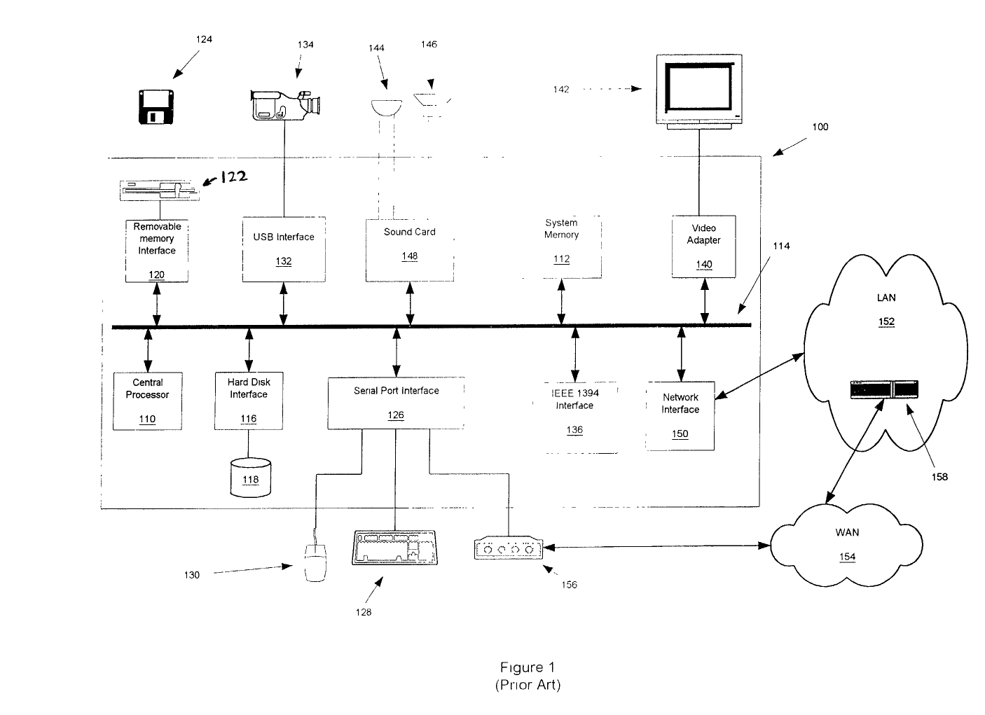

Various embodiments of the present invention may be implemented on a computer system, such as computer 100 shown in FIG. 1. Computer 100 includes a central processor 110, a system memory 112 and a system bus 114 that couples various system components including the system memory 112 to the central processor unit 110. System bus 114 may be any of several types of bus structures including a memory bus or memory controller, a peripheral bus, and a local bus using any of a variety of bus architectures. The structure of system memory 112 is well known to those skilled in the art and may include a basic input/output system (BIOS) stored in a read only memory (ROM) and one or more program modules such as operating systems, application programs and program data stored in random access memory (RAM).

Computer 100 may also include a variety of interface units and drives for reading and writing data. In particular, computer 100 includes a hard disk interface 116 and a removable memory interface 120 respectively coupling a hard disk drive 118 and a removable memory drive 122 to system bus 114. Examples of removable memory drives include magnetic disk drives and optical disk drives. The drives and their associated computer-readable media, such as a floppy disk 124 provide nonvolatile storage of computer readable instructions, data structures, program modules and other data for computer 100. A single hard disk drive 118 and a single removable memory drive 122 are shown for illustration purposes only and with the understanding that computer 100 may include several of such drives. Furthermore, computer 100 may include drives for interfacing with other types of computer readable media.

A user can interact with computer 100 with a variety of input devices. FIG. 1 shows a serial port interface 126 coupling a keyboard 128 and a pointing device 130 to system bus 114. Pointing device 130 may be implemented with a mouse, track ball, pen device, or similar device. Of course, one or more other input devices (not shown) such as a joystick, game pad, satellite dish, scanner, touch sensitive screen or the like may be connected to computer 100.

Computer 100 may include additional interfaces for connecting devices to system bus 114. FIG. 1 shows a universal serial bus (USB) interface 132 coupling a video or digital camera 134 to system bus 114. An IEEE 1394 interface 136 may be used to couple additional devices to computer 100. Furthermore, interface 136 may configured to operate with particular manufacture interfaces such as FireWire developed by Apple Computer and i.Link developed by Sony. Input devices may also be coupled to system bus 114 through a parallel port, a game port, a PCI board or any other interface used to couple and input device to a computer.

Computer 100 also includes a video adapter 140 coupling a display device 142 to system bus 114. Display device 142 may include a cathode ray tube (CRT), liquid crystal display (LCD), field emission display (FED), plasma display or any other device that produces an image that is viewable by the user. Additional output devices, such as a printing device (not shown), may be connected to computer 100.

Sound can be recorded and reproduced with a microphone 144 and a speaker 146. A sound card 148 may be used to couple microphone 144 and speaker 146 to system bus 114. One skilled in the art will appreciate that the device connections shown in FIG. 1 are for illustration purposes only and that several of the peripheral devices could be coupled to system bus 114 via alternative interfaces. For example, video camera 134 could be connected to IEEE 1394 interface 136 and pointing device 130 could be connected to USB interface 132.

Computer 100 can operate in a networked environment using logical connections to one or more remote computers or other devices, such as a server, a router, a network personal computer, a peer device or other common network node, a wireless telephone or wireless personal digital assistant. Computer 100 includes a network interface 150 that couples system bus 114 to a local area network (LAN) 152. Networking environments are commonplace in offices, enterprise-wide computer networks and home computer systems.

A wide area network (WAN) 154, such as the Internet, can also be accessed by computer 100. FIG. 1 shows a modem unit 156 connected to serial port interface 126 and to WAN 154. Modem unit 156 may be located within or external to computer 100 and may be any type of conventional modem such as a cable modem or a satellite modem. LAN 152 may also be used to connect to WAN 154. FIG. 1 shows a router 158 that may connect LAN 152 to WAN 154 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and computer 100 can be operated in a client-server configuration to permit a user to retrieve web pages from a web-based server. Furthermore, any of various conventional web browsers can be used to display and manipulate data on web pages.

The operation of computer 100 can be controlled by a variety of different program modules. Examples of program modules are routines, programs, objects, components, data structures, etc., that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

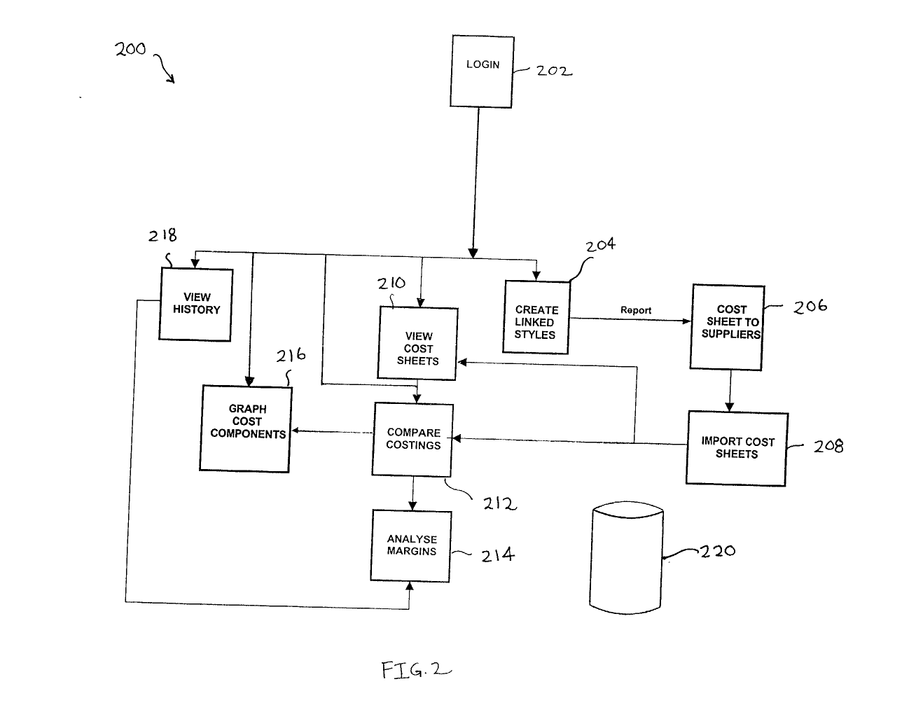

One embodiment of the invention that may be implemented by a product retailer on the computer 100 is shown in FIG. 2. In particular, FIG. 2 schematically illustrates various operational components of a Fact Based Negotiation Tool 200 according to one embodiment of the invention, along with arrows indicating one conventional order of use of the different components.

As seen in this figure, the Fact Based Negotiation Tool 200 includes a login operation component 202. As will be explained in detail below, this component serves as the gateway for a user of the Fact Based Negotiation Tool 200 to access the information contained within the Fact Based Negotiation Tool 200. The Fact Based Negotiation Tool 200 also includes a create linked styles component 204 for defining products and linking them to a supplier, a cost sheet preparation component 206 for preparing and providing cost sheets to suppliers, and a cost information import component 208 for importing cost information from cost sheets that have been filled out and returned by suppliers. As will also be discussed below, these components 204-208 cooperate together to allow a user to define a product that will be purchased, specify the characteristics of the product for which a supplier of the product will provide cost information, and import that cost information into the Fact Based Negotiation Tool 200.

In addition, the Fact Based Negotiation Tool 200 includes a component 210 for viewing the imported cost information, a component 212 that may be used to compare cost information from different suppliers, and an analyze margins component 214 that is used to analyze margins calculated from the pricing information provided by the suppliers. Further, in order to assist the user in obtaining the most benefit from the cost information provided by the suppliers, the Fact Based Negotiation Tool 200 includes a component 216 for graphically displaying imported cost information. It also includes a component 218 for viewing the history of product and cost information relating to different suppliers. The function and use of each of these components 202-218 will be explained in detail below.

The Fact Based Negotiation Tool 200 also includes a database 220, for storing the various pieces of information to be manipulated by the Fact Based Negotiation Tool 200. As will be appreciated by those of ordinary skill in the art, this database 220 can be implemented using commercially available database software, such as that created and sold by Oracle Corporation. With some preferred embodiments of the invention, the database 220 may be hosted on a server computer accessible to remotely located users over a network, such as the Internet or an intranet provided by the retailer. Alternate embodiments of the invention are possible, however. For example, the database 220 may be maintained on a mainframe computer accessible through connected workstations, or the database 220 may be shared among computers connected through a network such as the Internet or an intranet provided by the retailer.

With various embodiments of the invention, the components 202-218 may be embodied by one or more software programs that can be contained on storage medium, like the hard disk drive 118, and implemented on a programmable computer, such as the computer 100. As will be appreciated, the software programs may operate individually or may be integrated together. Alternately, one or more of the components 202-218 may be implemented by electronic circuitry, operating alone or in conjunction with the computer 100.

As will be appreciated by those of ordinary skill in the art, much of the information stored by the Fact Based Negotiation Tool 200, such as cost information and margin information, is sensitive and is likely to be maintained in confidence by the retailer.

Accordingly, the Fact Based Negotiation Tool 200 initially employs the login component 202 to prevent unauthorized users from accessing the information contained by the Fact Based Negotiation Tool 200. The login component 202 may employ any conventional login procedure that obtains and authenticates a user's identity. For example, the login component 202 may require a user to provide his or her user name and a password authenticating the user's identity.

According to some preferred embodiments of the invention, different users will be able to employ different components of the invention. Typically, many retail organizations will have a “buyer” who is responsible for purchasing products that are going to be sold in a particular department. A department store, for example, may have a buyer who is responsible for purchasing shoes for its women's casual shoes department. Accordingly, when using the Fact Based Negotiation Tool 200, this buyer should have access to all of the functions provided by the components 202-218, and be authorized to modify all of the cost information and other data stored by the Fact Based Negotiation Tool 200. On the other hand, the buyer may be restricted from accessing cost, sales price and margin information relating to other departments. Still further, a multi-channel retailer (e.g., a retailer having a department store and an Internet or catalog “store”) may have a separate women's casual shoes department for each retail channel. With this arrangement, the buyer for the women's casual shoes department of one channel may be restricted from accessing cost, sales price and margin information for another women's casual shoes department.

Further, a department's buyer may have various assistants (e.g., buyer assistants) that may need to review some or all of the data stored in the Fact Based Negotiation Tool 200, but who are not authorized to modify, add, or delete information to or from the Fact Based Negotiation Tool 200. Still further, a supplier who has submitted pricing information to the Fact Based Negotiation Tool 200 may wish to subsequently review that information for errors. The retailer maintaining the Fact Based Negotiation Tool 200, however, will want to ensure that the supplier cannot access cost information that has been provided by other suppliers. Accordingly, the login component 202 may not only authenticate the identity of the user, but it may also determine which of the components 202-218 may be employed by that user, how each of those components may be employed to access the database 220, and what information the user may access in the database 220. Various techniques and systems for restricting a user's access to a database and use of an application implemented on a computer are well known to those of ordinary skill in the art, and thus will not be discussed here in detail.

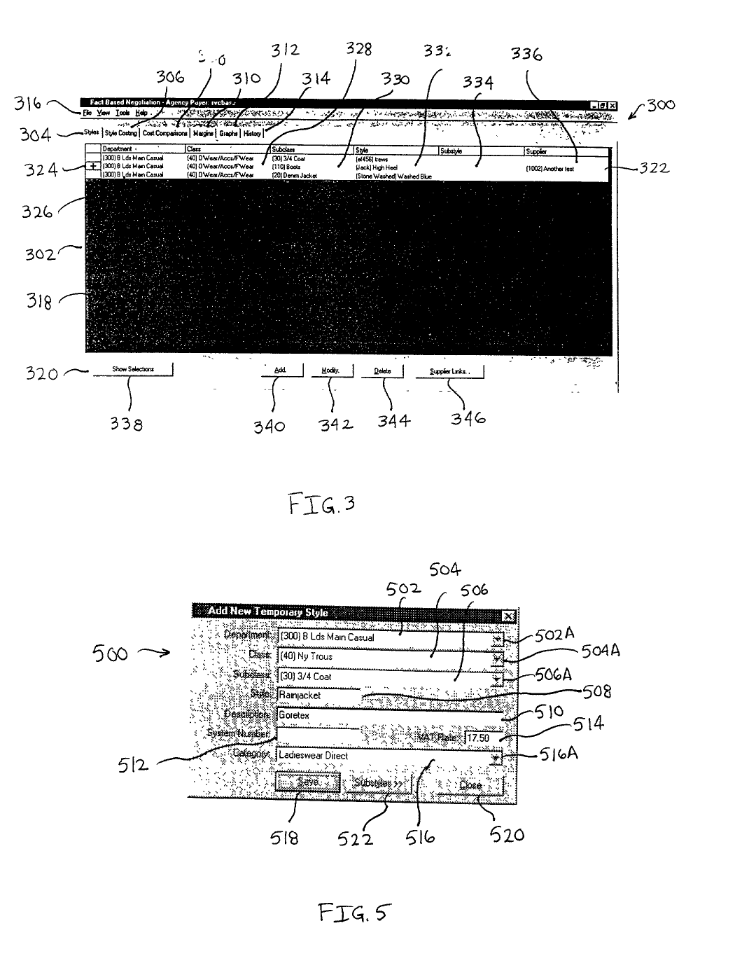

After a user has logged into the Fact Based Negotiation Tool 200 through the login component 202, the user is provided with an initial user interface. With some preferred embodiments of the invention, this interface is a general user interface that conveniently allows a user to manipulate and view the information contained in the Tool 200. One possible example of such an interface is the graphical user interface 300 shown in FIG. 3. As seen from this figure, this graphical user interface 300 can display a number of different sub-interfaces, referred to hereafter as “tab” interfaces, as each of these interfaces are accessed by activating a tab shown on the main graphic user interface 300. For example, in FIG. 3, the “styles” tab interface 302, referenced by the styles tab 304, is prominent in the graphic user interface 300. Other tab interfaces are accessible through tabs shown on the main graphic user interface 300, which include the “style costing” tab 306, the “cost comparisons” tab 308, the “margins” tab 310, the “graphs” tab 312, and the “history” tab 314. The purpose and operation of interfaces accesses through each of these tabs 304-314 will be discussed in detail below.

In addition to the tabs 304-314, the main graphic user interface 300 also includes a toolbar 316. As is known in the art, the toolbar 316 includes a number of command menu titles (e.g., “File,” “View,” “Tools,” and “Help”). When a command menu title is activated, the graphical user interface 300 provides a drop-down menu showing various commands relating to the title. The user can then activate the commands on the drop-down menu.

Turning now to the “styles” tab interface 302, this interface may include a styles section 318 and a command button section 320. The styles section 318 may have a product record table 322 displaying one or more product records for each product managed by the Fact Based Negotiation Tool 200 that is accessible to the user. Of course, with alternate embodiments of the invention, the product record table 322 may only display those product records accessible to the user that are selected by the user for manipulation with the Tool 200. With the illustrated embodiment, each row of the table makes up a single product record. A row includes a selection field 324 for selecting the product record, as will be explained below. Each product record in the table also contains a department field 326, identifying the department for which the product will be purchased (e.g., main casual department), a class field 328 identifying the class in which the product is categorized (e.g. outerwear), and a subclass field 330 identifying a subclass category for the product (e.g., boots). Each product record also includes a style field 332 identifying the style of the product (e.g., high heel), and a substyle field 334 identifying a substyle of the product (e.g., a particular size or color), if any. Further, each product record in the table 322 includes a supplier field 336 identifying the supplier who may provide that product to the retailer. The supplier field 336 may identify the supplier by name, by a code number, or both. Of course, those of ordinary skill in the art will appreciate that other table formats and even alternate techniques for displaying the contents of the product records may be employed with different embodiments of the invention.

As will become apparent from the following discussion, a user may employ the style interface 302 to select or designate the different products for which the user wants to review or manipulate cost, sales price, and margin information. In some preferred embodiments of the invention, the product record table 322 lists all of the product records accessible to the buyer for viewing and/or manipulation. A user may then designate one or more of the product records contained in the product record table 322 by “marking” the selection field 324 for that product record. For example, as may be seen in FIG. 3, the product record containing the style “high heel jackboots” is one of the product records that a user has selected for viewing or manipulation.

Various methods of selecting a product record in this fashion are well known in the art. For example, a user may mark a selection field 324 by moving a displayed cursor over the selection field 324 and then activating a button on a pointing device for the cursor one or more times (i.e., by “clicking” on the selection field 324 of the product record). Of course, those of ordinary skill in the art will appreciate that other well-known methods for selecting a product record may be used with alternate embodiments of the invention. Once one or more product records have been designated using the styles interface 302, cost, sales price and margin information associated with the selected product records can be viewed and/or manipulated by using the other interfaces accessed through tabs 306-314.

The command button section 320 of the styles interface 302 may include five command buttons. These are a show selections button 338, an add button 340, a modify button 342, a delete button 344, and a supplier links button 346. As will be discussed below, the add button 340, modify button 342, delete button 344, and supplier links button 346 are used to add, modify, and delete product records to and from the product record table 322. The show selections button 338 causes the styles tab interface 302 to display a modified product record table (not shown), which includes only the product records that have already been selected by the user. Thus, by activating the show selections button 338, the user can quickly separate the specific product records he or she has selected from the complete list of product records available for review.

Before a retailer can obtain cost information from suppliers for a product, the retailer must first specify the product that the retailer wishes the suppliers to provide. Accordingly, the Fact Based Negotiation Tool 200 conveniently allows a user to specify a product for purchase from one or more suppliers, along with the general features of the product, which are referred to as the product's “style.” The Fact Based Negotiation Tool 200 may also allow a user to specify more detailed features of the product, referred to as “substyles.” For example, the user may define the material and sewing pattern of a men's trench coat as the style of the coat, and then define each size of the coat (e.g., small, medium, large and extra large) as a substyle of the coat.

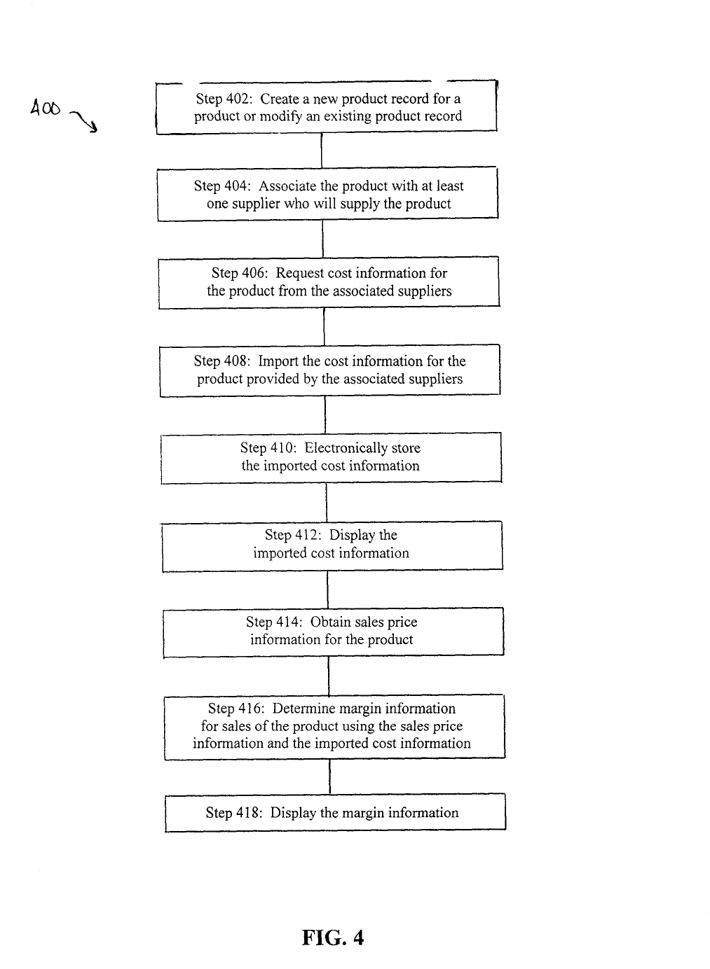

After the user has specified a product, the user can then employ the Tool 200 to “link” the product to one or more suppliers. That is, the user can generate a new product record associating the product with a particular supplier, thereby creating a product record on the product for each supplier. After creating a product record, the user can then further employ the Fact Based Negotiation Tool 200 to obtain and associate cost, sales price and margin information for the product record. A method 400 of creating a product record and obtaining and displaying cost, sales price and margin information for the product record is shown in FIG. 4. The operation of the Tool 200 according to this method will be discussed with reference to FIGS. 5-15.

First, in step 402, the user creates a product record for a new product, or modifies an existing product record, in order to specify a product for purchase from a supplier. To add, modify, or even delete a product record, the user initiates the create linked styles component 204 by activating any of the buttons 340-344. If the user activates the add button 340 to create a new product record, then the create linked styles component 204 provides the user with a user interface for creating a new product record, such as the user interface 500 shown in FIG. 5. As seen in this figure, the user interface 500 includes a number of fields 502-516, and a plurality of command buttons 518-522.

Field 502 corresponds to the department from which the product will be sold. Thus, the user may type in the product's department in field 502. Alternately, the field 502 may include a pull-down menu (not shown) activated by a pull-down menu button 502A listing departments that have already been specified for the Fact Based Negotiation Tool 200. As is known in the art, the user can then select an existing department listed on the pull-down menu rather than retyping the department in the field 502.

Similarly, field 504 corresponds to the class of the product, and also may have a pull-down menu (not shown), activated by pull-down menu button 504A, for selecting an existing class. The field 506 corresponds to the subclass of the product, and may also include a pull-down menu (not shown), activated by a pull-down menu button 506A, for selecting an existing subclass. The field 508 then corresponds to the style of the product, while the field 510 corresponds to the description of the product. The user may conveniently employ field 510 to store various details explaining the features of the product, such as the material with which the product is made.

The field 512 corresponds to a system number of the product, which the retailer can assign to the product in order to more easily identify the product later. The field 514 corresponds to a value added tax (VAT) rate assessed for the sale of the product to a consumer. The field 516 then corresponds to the category in which the product is classified, and also may include a pull-down menu (not shown), activated by a pull-down menu button 516A, for selecting an existing category.

To create a new product, the user enters the information defining the product in the relevant fields 502-516. Once the user is satisfied that the product has been sufficiently defined by the contents of the fields 502-516, the user can save the product definition to the Fact Based Negotiation Tool 200 by activating the save button 518. If, on the other hand, the user decides not to save the product definition, the user can simply close the interface 500 by activating the close button 520. It should be noted that other embodiments of the invention may employ any combination of additional or alternate fields to record information required by the retailer to specify a product for potential suppliers. For example, with other embodiments of the invention, the interface 500 may include fields for tariffs or regional sales taxes. Alternately, some embodiments of the invention may omit, e.g., the field 514 for defining a VAT rate.

For some products, the information contained in the single style field 508 may not be sufficient to distinguish the product from other, similar products. Also, the buyer may want to be able to separately consider different characteristics, such as size or color, of a particular product. Accordingly, with some embodiments in the invention, the user may further define features of a product by activating the substyles button 522. When this button 522 is activated, the Fact Based Negotiation Tool 200 provides the user with an interface for defining the additional features, such as the modified interface 600 shown in FIG. 6. Like the interface 500, the interface 600 includes the fields 502-516 and the buttons 518-522. The interface 600 further includes, however, the fields 602-608.

The field 602 corresponds to existing substyles, and the user can employ this field to select a substyle characteristic that has been previously defined. The field 604 then corresponds to the substyle code for the product, while the field 606 corresponds to the VAT rate for the substyle of the product. Distinguishing a different VAT rate for a substyle of a product may be helpful to the user. For example, some countries may charge a VAT fee for all clothing except for children's clothes sized to fit children of ages 12 and below. In this situation, the interface 600 can be used to define a substyle of a product (e.g., pajamas) such that the characteristic of the substyle is a size to fit children below the age of 12. The user can then employ the field 606 to specify a VAT rate of zero for this substyle. The field 608 then corresponds to a further description of the product. With the embodiment illustrated in FIG. 6, the user cannot modify the contents of the fields 502-508 and 516. Other embodiments of the invention, however, may allow the user to modify some or all of the contents of these fields from the interface 600. Still further, other embodiments of the invention may employ additional or alternate fields as suitable for the retailer, or omit some of the fields (e.g., field 606) as suitable for the retailer.

Once the user has specified the additional features of the product in interface 600, the user can save this information to the Fact Based Negotiation Tool 200 by activating the save button 518. Similarly, the user can close the interface 600 by activating the close button 520. If the user wishes to return to the previous interface 500, the user activates button 522. If the user wishes to remove an existing substyle characteristic shown in the field 602, the user simply selects that substyle and activates the remove button 610. Thus, through interface 500 and interface 600, the user can employ the component 204 to specify a new product. Once a product has been specified by defining its style or substyle characteristics, the Fact Based Negotiation Tool 200 then lists a single product record for this product in the product record table 322.

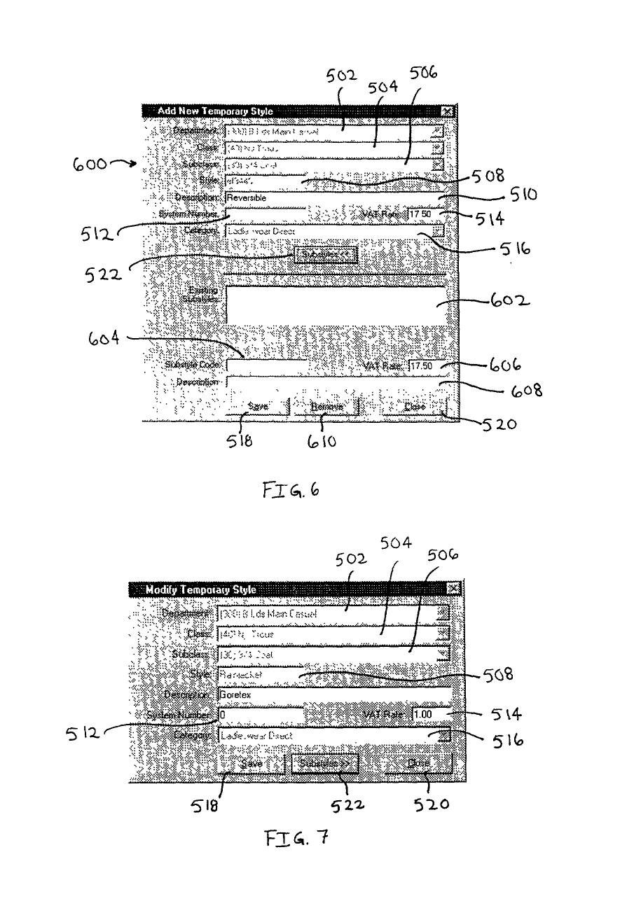

If, rather than defining a new product, the user instead wishes to modify the features of a product listed in an existing product record, the user selects the product record in interface 302 and then activates the modify button 342. This causes the component 204 to provide the user with a user interface for modifying an existing product record, such as the interface 700 shown in FIG. 7. Interface 700 is similar in appearance and operation to the interface 500, but the interface 700 does not allow the user to modify the contents of fields 502-508 and 516. Instead, the user can modify only the contents of fields 510-514.

If the user wishes to delete an existing product record from the product record table 322, the user can do so with the delete button 344. The user first designates the product record to be deleted in interface 302, and then activates the delete button 344. If more than one product is designated, then each of the designated products is deleted.

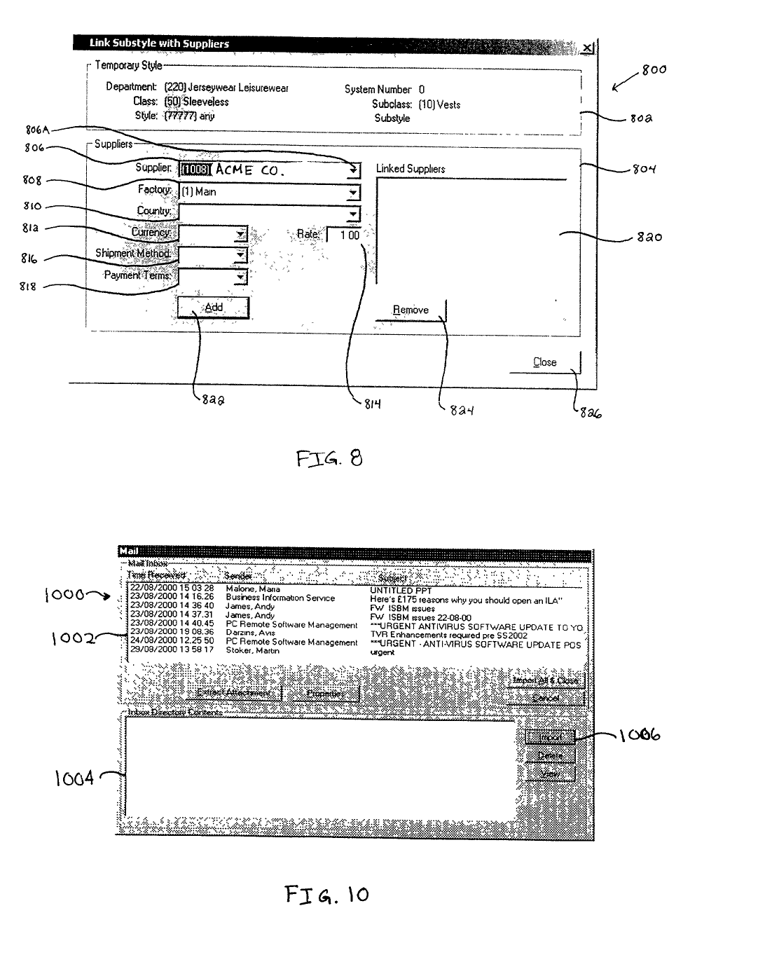

After the user has created a product record for a new product, or modified an existing product record for a product, in step 404 the user associates the product with at least one supplier who will provide the product to the retailer. To do this, the user first selects the product record for the product from the product record table 322 shown in FIG. 3. Next, the user initiates the create link styles component 204 by activating the supplier links button 346. In response to the activation of this button, the Fact Based Negotiation Tool 200 provides the user with an interface for linking a product with a supplier, such as the interface 800 shown in FIG. 8.

Interface 800 includes a product information portion 802 and a field portion 804. The product information portion 802 displays the features of the product, such as the product's department, class, subclass, style, substyle, and system number. The field portion 804 includes fields 806-820, and buttons 822 and 824. The field 806 is used to designate an identifier (e.g., a name or code number) for the supplier who may supply the product. The user may manually type in the supplier identifier in this field (by, e.g., typing the supplier's number, name, or both), or may alternatively select the identifier for an existing supplier from a pull-down menu (not shown) activated by the pull-down button 806A. The field 808 then is used to identify the supplier's factory where the product will be manufactured. The field 810 contains the country in which the supplier is located. The field 812 corresponds to the currency the supplier prefers for sales transactions, while the field 814 contains the exchange rate at which the currency converts to the retailer's preferred currency. The field 816 designates the method by which the supplier will ship the product to the retailer, while the field 818 may be used to designate a percentage discount the supplier gives for early payment. Of course, those of ordinary skill in the art will appreciate that, with alternate embodiments of the invention, the interface 800 can include alternate or additional fields for providing other information desired by the retailer.

After the user has completed each of fields 806-818 to specify a supplier, the user can then associate that supplier with the product by activating the add button 822. The supplier's name will then be listed in field 820 as a supplier for the product, and the Fact Based Negotiation Tool 200 will create a new product record for the product that includes the supplier. As will be appreciated by those of ordinary skill in the art, the user may employ the interface 800 to create product records associating a number of different suppliers with the product by listing the suppliers in the field 820. Alternatively, if the user wishes to remove a supplier's association with a selected product, the user may select the name of that supplier in the field 820 and activate the remove button 824, which deletes the product record linking that supplier to product. Of course, the user may close the interface 800 by activating the close button 826.

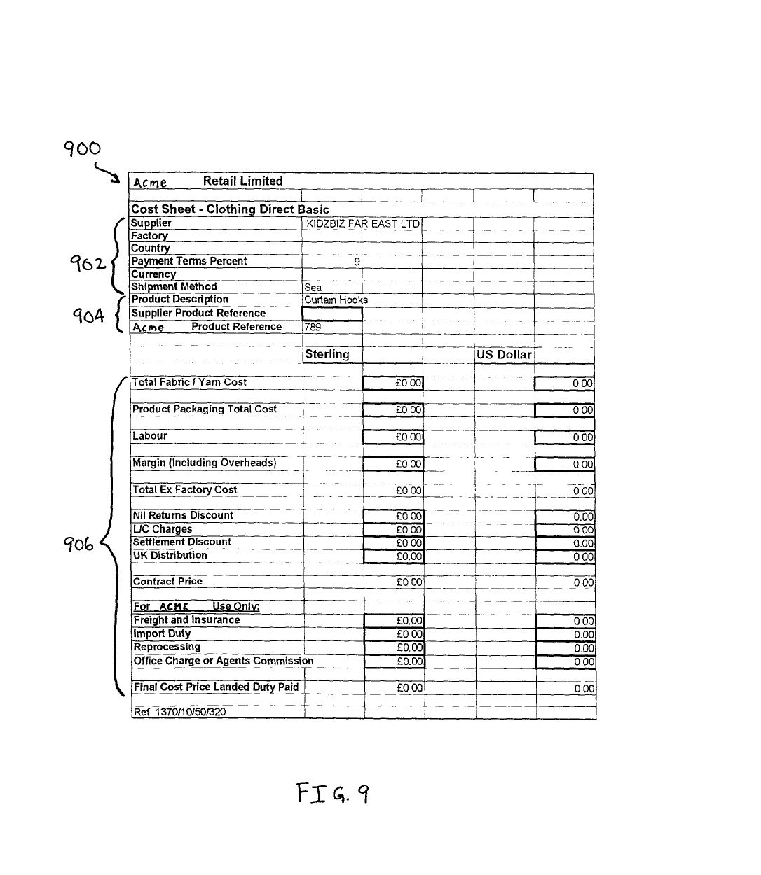

Once the user has specified a product, and created a product record linking or associating one or more suppliers with the product, the user requests cost information for the product from the suppliers in step 406. To do this, the user may send a cost sheet for the product to one or more of the suppliers associated with that product. An example of such a cost sheet 900 is shown in FIG. 9. As seen in this figure, the cost sheet 900 includes a number of fields 902 corresponding to information regarding the supplier, such as the supplier's name, a particular factory for the supplier, the supplier's country, the supplier's payment terms discount, the currency used by the supplier, and the supplier's shipment method. The cost sheet 900 also includes a number of fields 904 relating to information for the product, such as the product's description, the supplier's reference number for the product, and the retailer's reference number for the product.

In addition, the cost sheet 900 has a number of fields 906 that relate to various costs for manufacturing and delivering the product to the retailer. These costs may include costs for different manufacturing steps or materials employed to make the product, such as yarn costs, packaging costs, labor costs, and margin. These fields may also include various delivery and distribution costs, such as freight and insurance costs, an import duty, commission costs, etc. The buyer may use the cost information provided in these fields, e.g., to negotiate cost with the suppliers. For example, a buyer may note that one supplier has quoted a higher packaging cost than other suppliers. A buyer may then use this discrepancy to negotiation a lower total cost from that supplier. Further, the fields 906 will typically also include a field corresponding to the final cost of the product to the retailer. As seen in FIG. 9, the cost fields 906 may describe the various costs associated with the product in more than one currency, such as the British Pound Sterling and the U.S. Dollar.

With some preferred embodiments of the invention, the cost sheets are embodied by electronic files, such as a spreadsheet files or a database files. For example, the costs sheets may conveniently be created in an electronic file format compatible with a well know, commercially available spreadsheet program, such as Microsoft® Excel. This allows the cost sheet to be delivered to each supplier by electronic communication, such as electronic mail.

It should also be noted that the cost sheet 900 shown in FIG. 9 is exemplary, and various types of cost sheets may be employed for different products. For example, a different product may have cost field for a material cost different from or in addition to the total fabric/yarn cost. A separate cost sheet may be generated for each product, based upon the particular cost information desired by the retailer.

As may be seen in FIG. 9, the retailer may prepare each cost sheet by adding the information already known to the retailer, such as the supplier name, product description and the retailer's reference number for the product. The incomplete cost sheets are then sent to one or more of the suppliers associated with the product for completion. For example, the cost sheets may be sent to each supplier associated with the product. As previously noted, some preferred embodiments deliver the incomplete cost sheet to the suppliers by electronic transmission, such as electronic mail, but other delivery methods, such as regular parcel mail and facsimile transmission, may also be employed.

After receiving the cost sheet, a supplier enters its transaction and estimated cost information in each corresponding empty field. The supplier then returns the completed cost sheet to the retailer, so that the Tool 200 can import the cost information contained in the cost sheet into the database 220 in step 408. If the cost sheet is embodied in an electronic file, such as a Microsoft® Excel compatible file, then the completed cost sheet can be returned to the retailer via electronic transmission, such as electronic mail. With this arrangement, the user can employ the Fact Based Negotiation Tool 200 to import the information from the completed cost sheet in step 408, using conventionally known data import techniques that will be apparent to those of ordinary skill in the art. In the illustrated embodiment, the user can access a command from, e.g., the “File” command menu in task bar 316 of user interface 300, to import cost information from a cost sheet transmitted by electronic mail.

Activating the data import command initiates component 208. In response, the Fact Based Negotiation Tool 200 provides the user with an interface for importing cost information from an electronic mail message, such as the interface 1000 shown in FIG. 10. This interface 1000 includes an electronic mail inbox field 1002 and an inbox directory contents field 1004. The field 1002 lists all of the electronic mail messages received by the user. The user may designate one or more of the received messages containing completed cost sheets from a supplier, so that each designated message is listed in the inbox directory contents field 1004. The user can then electronically import the information from the completed cost sheet or sheets to the Fact Based Negotiation Tool 200 by activating button 1006. In this manner, the Fact Based Negotiation Tool 200 can be used to easily obtain pricing information from a number of different suppliers who are designated to supply a product to the retailer.

With this embodiment, the cost information is imported from electronic mail messages addressed to the user. Other embodiments, however, may be configured to import cost information from electronic mail messages addressed to other parties, including an address for the Tool 200 itself. Of course, if the cost sheet is embodied in another format, such as paper, the information from the completed cost sheet can be manually imported or scanned into the Fact Based Negotiation Tool 200. In any case, in step 408, the user imports the cost information from the completed cost sheet into the Fact Based Negotiation Tool 200. Once the Tool 200 has imported the cost information, it electronically stores the cost information in the database 220 in step 410. The cost information is then associated with the product record including the supplier providing the cost information.

Returning briefly to FIG. 9, it can be seen that the cost sheet 900 includes some fields that are to be completed by the retailer (e.g., freight and insurance, import duty, reprocessing, etc.) With various embodiments of the invention, the retailer may import the information for these fields into the database 220 before or after the supplier has returned the cost sheet 900.

Once the cost information for a product has been imported by the Fact Based Negotiation Tool 200, electronically stored in the database 220, and associated with the product record, the user can optionally view this cost information in step 412 by using the style costing tab 306. More particularly, the user designates the product records listed in product record table 322 for which the user would like to view cost information. The user then accesses the costing tab 306 to initiate the view cost sheets component 210. In response, the view cost sheets component 210 provides the user with an interface for viewing the cost information, such as the interface 1100 shown in FIG. 11. This interface 1100 enables the buyer to examine and review the various cost components associated with the product as estimated by the supplier for the product.

As seen in FIG. 11, the style costing interface 1100 includes fields 1102-1116 containing information relating to the supplier. More particularly, field 1102 contains the supplier's name, field 1104 contains the method of shipping the product, field 1106 identifies the factory at which the product will be manufactured, field 1108 contains the supplier's country, field 1110 contains the supplier's preferred currency, field 1112 contains the exchange rate for the supplier's preferred currency against the retailer's preferred currency, field 1114 contains the supplier's discount term, and field 1116 contains the supplier's reference number. This information is preferably imported from the supplier definition information entered in interface 800 (shown in FIG. 8), but may be edited by the user through interface 1100. The style costing interface 1100 may also list various information relating to the product, such as the product's category, VAT rate, and system number. The values of some or all of these fields may be imported from the cost sheet 900, but, with various embodiments of the invention, these values may also be added or edited using the style costing interface 1100. In addition, the style costing interface 1100 includes a field 1118. The user may enter miscellaneous information (i.e., notes) into this field for future reference.

Conveniently, the field 1120 displays the cost information imported from the cost sheet provided by the supplier. Thus, the user can review the information in field 1120 to quickly ascertain the various costs associated with purchasing the product from the associated supplier. The style costing interface 1100 also has fields 1122 and 1124, corresponding to the retailer's selling price for the product and the retailer's selling volume for the product, respectively. Accordingly, in step 414, the user enters an anticipated sales price for the product into the field 1122.

It should be noted that the volume information corresponding to field 1124 may be obtained from the cost sheet 900, or the user may alternately provide the volume information. For example, a supplier may provide the user with different cost information for different product volumes (e.g., the supplier may provide a first cost sheet with a first set of cost information for the purchase of one volume of the product, and a second cost sheet with a second set of cost information for the purchase of another volume of the product). The Tool 200 may then create different product records for each volume, and display the volume information for that product record in field 1124. Alternately, the user can simply provide a value for the field 1124 corresponding to the anticipated number of products to be sold from the user's department.

With the Fact Based Negotiation Tool 200 according to the invention, after the user enters the retailer's selling price in field 1122 and the expected volume of the retailer's sales of the product in field 1124, the Tool 200 calculates the retailer's profit margin for sales of the product in step 416, and in step 418 displays the calculated profit margin information in the field 1126. For example, the Fact Based Negotiation Tool 200 may subtract the final cost of obtaining the product from the supplier (obtained from the information provided in the cost sheet) from the retailer's selling price, and then divide this difference by the retailer's selling price. However, various embodiments of the invention can calculate the retailer's margin using other techniques, and the particular method of calculating the margin information will vary from retailer to retailer. That is, a Fact Based Negotiation Tool 200 according to various embodiments of the invention may employ any method of determining margin information that is desired by the retailer, and the embodiments of the invention are not limited to a particular method of determining profit margin information. Thus, the style costing interface 1100 allows the user to view the costs associated with purchasing a product from a specific supplier. It also allows the buyer to review the margin of profit that can be expected from each sale of the product when the product is purchased from that supplier. Further, depending upon the information contained in the cost sheet returned by each supplier, the Fact Based Negotiation Tool 200 will allow a user to determine individual manufacturing costs (e.g., total fabric cost) for similar products.

In addition to displaying the cost information for an individual product, the Fact Based Negotiation Tool 200 advantageously allows a user to compare cost information associated with a variety of product records. This allows the user to, for example, compare the costs of obtaining the same product from different suppliers, so that the buyer can select the supplier that can provide a product at the lowest cost. It also allows the user to compare the costs of obtaining similar products from the same or different suppliers, in order to determine which product and supplier combination will provide a suitable product at the lowest cost.

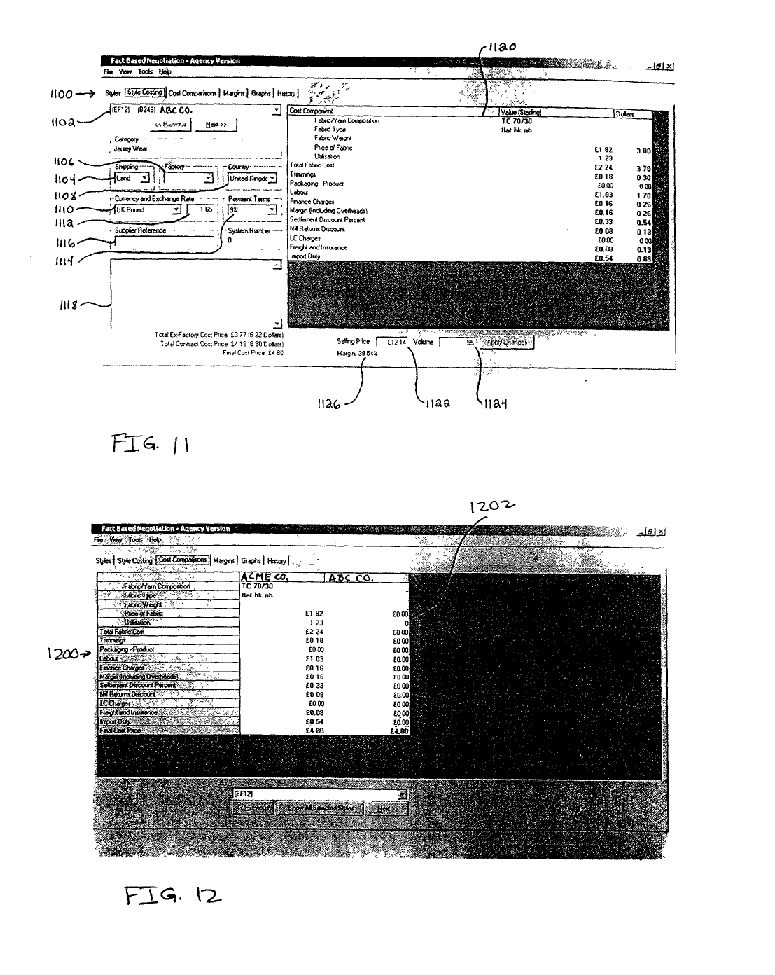

To compare the cost information associated with different product records in this manner the user first selects the product records in interface 302 for which the user would like to compare cost information. The user then activates tab 308. This initiates the compare costings component 212, causing the Fact Based Negotiation Tool 200 to display the interface 1200 shown in FIG. 12. As seen in this figure, the interface 1200 includes a table 1202 showing the cost information for each of the product records designated in the styles interface 302. This conveniently allows the user to compare both individual manufacturing costs and total product costs for the same products provided by different suppliers, or for similar products provided by the same or different suppliers.

By simultaneously displaying cost information for various product and supplier combinations to the user, the user can determine which supplier can provide a suitable product at the lowest price. The simultaneous display of this information may also assist the user in negotiating purchase costs with a supplier. For example, the user may note from the display that a first supplier has a significantly higher labor cost for supplying a product then other suppliers, but otherwise has lower material costs. The user can then point out the discrepancy in the labor costs to the first supplier in order to negotiate an overall lower cost for purchase of the product from the first supplier.

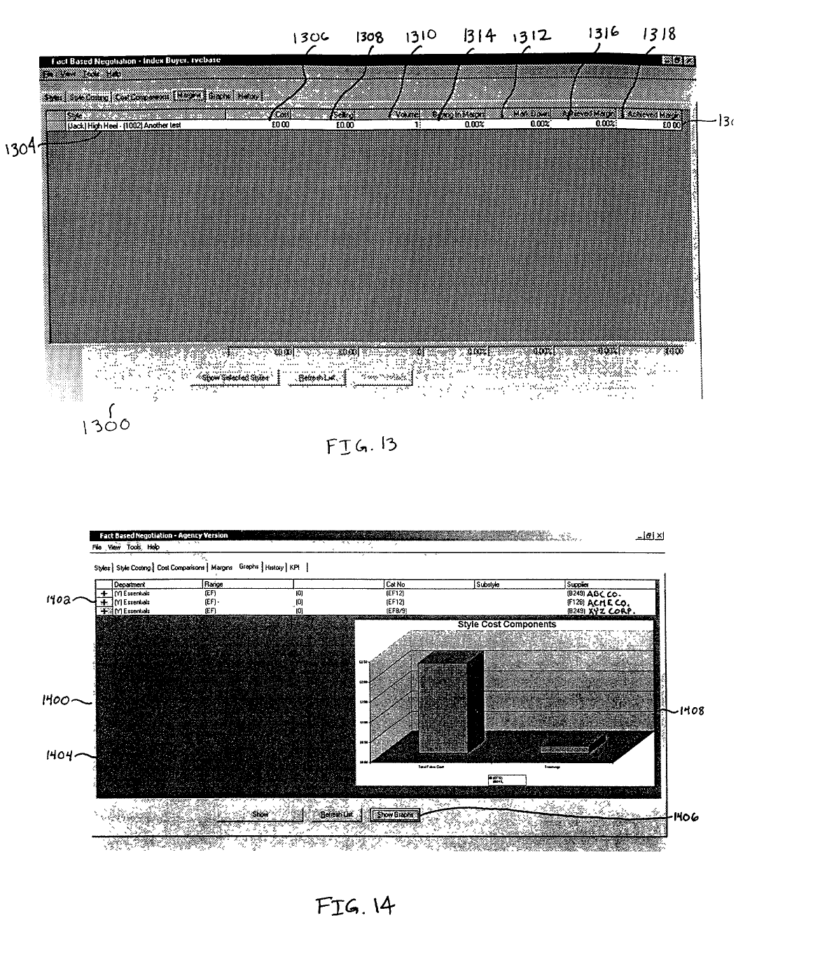

The Fact Based Negotiation Tool 200 also allows a user to conveniently review the profit margins associated with each product record. To review the margin of profit information associated with a product record, the user selects that product record or records in interface 302, and then activates tab 310. This initiates the analyze margins component 214, causing the Fact Based Negotiation Tool 200 to display the interface 1300 shown in FIG. 13. As seen in this figure, the interface 1300 includes a margin table 1302 containing the margin information corresponding to the selected product record or record. With some preferred embodiments of the invention, each entry in the margin table 1302 includes a field 1304 identifying both the product (by, e.g., its style) and its supplier. Each entry also preferably includes a field 1306 containing the final cost of the product to the retailer (obtained from the cost sheet completed by the supplier), a field 1308 containing the retailer's selling price (provided by the user, as discussed above) a field 1310 containing the retailer's anticipated selling volume (also provided by the user, as discussed above), and a field 1312 containing the retailer's expected return of the product from customers (entered by the user directly into this field). Of course, other embodiments of the invention may include alternate or additional fields as desired by the retailer, such as, e.g., a field for entering an expected markdown of the product.

Based upon this information, the Fact Based Negotiation Tool 200 displays the “buying in” margin (i.e., the retailer's profit margin before a markdown) in field 1314. Also, the Tool 200 displays the retailer's achieved margin (i.e., the profit margin) in fields 1316 and 1318. More particularly, the field 1316 contains the achieved margin for each product as a percentage of the selling price, while the field 1318 contains the achieved margin for each product in a currency value (e.g., in British pounds sterling). Again, as previously noted, any method desired by the retailer can be used to calculate the achieved margin, and the particular method for calculating this margin information may vary from retailer to retailer.

As shown in FIG. 13, the margin information for a number of different product records can be simultaneously displayed in the margin table 1302. This allows the user to compare the different margins for the same product when provided by different suppliers, or for similar products provided by the same or different suppliers. Moreover, when margin information for multiple products are viewed simultaneously, the total cost, selling price, volume, customer return and margin information for all of the selected product records is displayed in the total fields 1320 at the bottom of interface 1300. Thus, by selecting to view the margin information for each product the user may have in a department, the user can view the total cost, selling price, volume, mark down and margin information for the entire department. The user can then review the total cost, selling price, volume, customer return and margin information for different combinations of products from different suppliers, simply by selecting different combinations of product records. This allows the user to determine what products should be ordered from which suppliers in order to reduce the retailer's cost and/or maximize the retailer's profitability.

Conveniently, some embodiments of the invention allow the user to temporarily change the values displayed in any of fields 1306-1312, without changing the content of the corresponding product record. When the contents of any of fields 1306-1312 are edited in the interface 1300, however, the values in the fields 1316-1320 are recalculated and the new values displayed. This allows a buyer to determine the margin information for different cost, selling price, and volume values without permanently editing a product record. Thus, the user can determine the potential profit margin for sales in a department based upon proposed cost, selling price and volume values. This feature can assist the user, e.g., in negotiating a new cost for a product from a supplier, as the user will know in advance what proposed cost the user will need to negotiate from the supplier in order to achieve a hypothetical profit margin.

While the interface 1200 conveniently provides the user with cost comparison information for different product records, this interface displays this information in alphanumeric characters. This type of display may be difficult for a user to fully comprehend, however, particularly if the user has been reviewing alphanumeric characters for a prolonged period of time. Accordingly, the Fact Based Negotiation Tool 200 also allows the user to review one or more graphical displays of the cost comparison information provided in interface 1200.

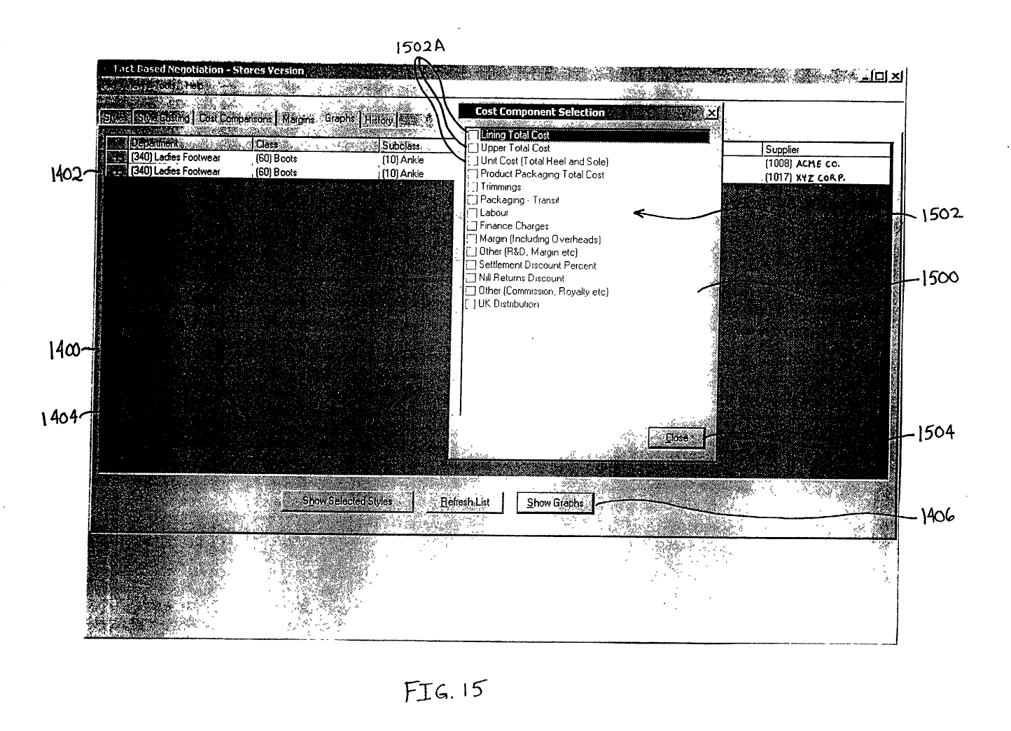

To use this feature, the user first designates the product records in interface 302 for which the user would like to graphically compare cost information, and then activates tab 312. This initiates the graph costs component 216, causing the Fact Based Negotiation Tool 200 to display the interface 1400 shown in FIG. 14. As seen in this figure, the interface 1400 includes a product records portion 1402 and a graph portion 1404. The product records portion 1402 displays each of the product records designated in the styles interface 302. When the user wants to graphically review or compare cost information, the user activates the show graphs button 1406. This causes the component 216 to display an interface for selecting one or more types of graphs 1408 of the cost information associated with the selected product records in the graph portion 1404 for display, such as the interface 1500 shown in FIG. 15.

As seen in this figure, the interface 1500 includes a list 1502 of possible graph types. For example, the list 1502 may include a graph type illustrating the total costs for a shoe's upper part, the cost for packaging, the labor costs, and others. Each type of graph included in the list 1502 has a corresponding selection box 1502A. To select a graph type for display, the user marks the selection box 1502A corresponding to the desired graph type. Once the user has selected the desired graph types for display, the user activates button 1504 to close the interface 1500 and display the selected graphs in interface 1400. Of course, those of ordinary skill in the art will appreciate that, with various embodiments of the invention, the interface 1500 can offer a number of different types of graphs, depending upon, e.g., the product records selected for display, the buyer's department, the graph types preferred by the retailer, etc.

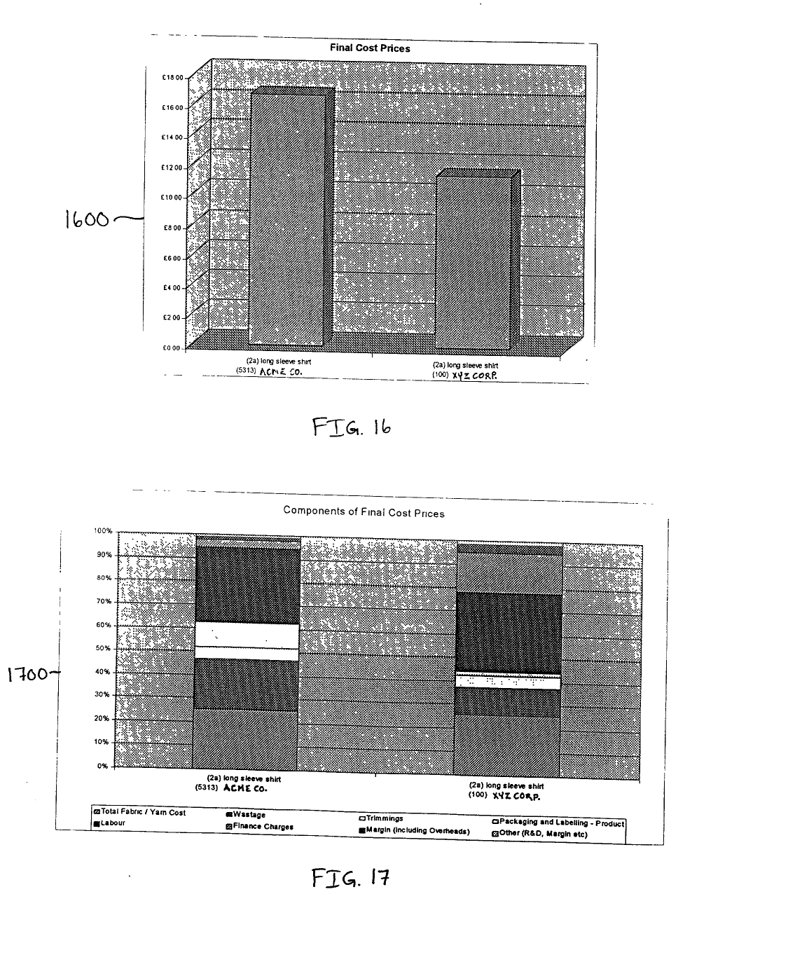

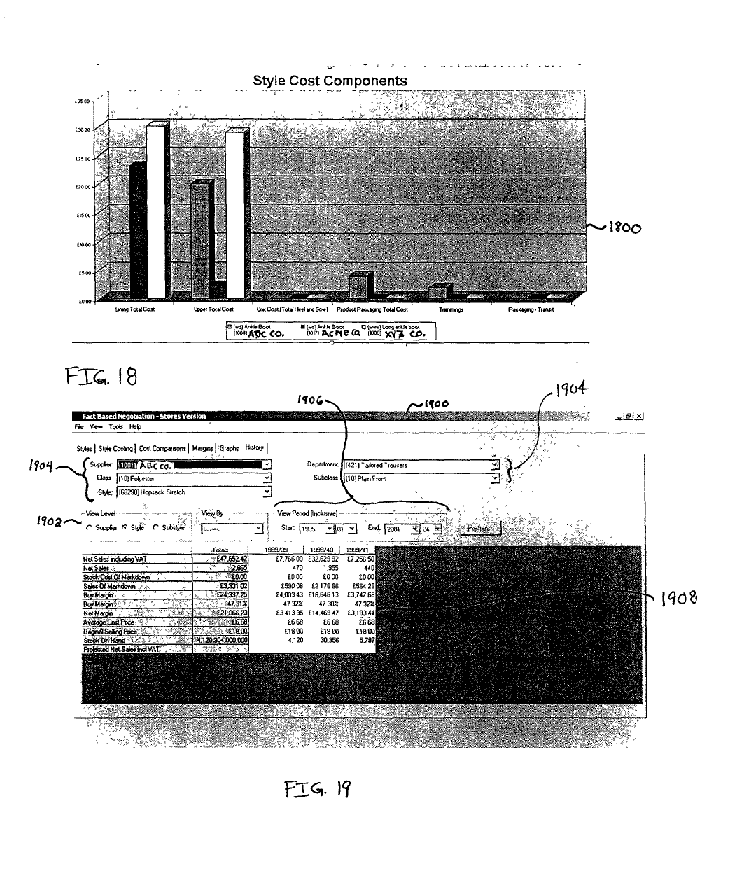

Examples of the different graphs that may be displayed by interface 1400 are shown in FIGS. 16-19. FIG. 16 illustrates a bar graph 1600 comparing the total cost, in British pounds sterling, of the same product from two different suppliers. FIG. 17, on the other hand, displays a bar graph 1700 comparing the percentage of each separate manufacturing cost (e.g., material, labor, packaging, etc.) for the same product from two different suppliers as a percentage of the total cost. Still further, FIG. 18 illustrates a bar graph 1800 comparing the absolute value, in British pounds sterling, of each separate manufacturing cost for the same product from two different suppliers. According to some embodiments of the invention, each of the graphs 1600-1800 may be generated using a conventional spreadsheet program, such as Microsoft® Excel. Of course, those of ordinary skill in the art will recognize that these graphs are merely exemplary, and that different embodiments of the Fact Based Negotiation Tool 200 according to the invention may provide any variety of graphic displays illustrating cost information, sales price information, or margin information as suitable for the retailer.

To assist the user in making purchase decisions, the Fact Based Negotiation Tool 200 also conveniently allows the user to view a history of information relating to the sales performance of a product or a supplier. To employ this feature, the user activates the tab 314. Activating this tab initiates the view history component 218, which in turn causes the Fact Based Negotiation Tool 200 to display interface 1900, shown in FIG. 19. As seen in this figure, the interface 1900 includes fields 1902-1906 for specifying the historical information to be displayed by the interface. More particularly, the user employs field 1902 to indicate whether the Tool 200 should display historical information for a supplier or a product style or substyle. The user then uses fields 1904 to designate a particular supplier, product, department and subclass, and fields 1906 to specify the time period that the historical information should cover.

After the user enters the appropriate data into these fields 1902-1904, the relevant historical data is then displayed in the field 1908. This historical information may include, for example, a supplier's net sales, customer returns, the buy margin obtained from the supplier's products, and the achieved margin obtained from the supplier's products. Of course, those of ordinary skill in the art will appreciate that the field 1908 may configured to display any historical information that may be desirable to a user. This information may be contained in the database 220 of the Fact Based Negotiation Tool 200, or it may be imported from another source, such as a remote database.

As will be apparent from the foregoing explanation, the Fact Based Negotiation Tool 200 allows a user to conveniently access a variety of product and supplier information, including cost information, cost comparison information for two or more products or suppliers, and margin information. This access advantageously permits a user to maximize a retailer's profitability.

As discussed above, some preferred embodiments of the Fact Based Negotiation Tool 200 according to the invention may be used in a network environment, where a user employs a computer 100 to access a database, maintained at a central server computer, to obtain the cost, product and other information manipulated by the Tool 200. With this arrangement, however, a user may occasionally be required to work away from his or her network connection, perhaps at a supplier in another country where a network connection is not available. Advantageously, some embodiments of the Fact Based Negotiation Tool 200 allow a user to remotely use the Tool 200 with a copy of the relevant data copied from the database 220. A user may thus continue to use the Fact Based Negotiation Tool 200 using, for example, a laptop computer or personal digital assistant that is not connected to the network.

In order to allow a user to remotely manipulate a copy of data obtained from the database 220, however, some embodiments of the Fact Based Negotiation Tool 200 will ensure that this copy of the data remotely manipulated by the user is synchronized with the data maintained in the database 220. To obtain this synchronization, the Fact Based Negotiation Tool 200 prevents one user from manipulating data while another user is remotely manipulating a copy of the data, as will be explained below.

As previously noted, the Fact Based Negotiation Tool 200 displays and manipulates data maintained in database 220, which may be a commercially available database such as that made and sold by Oracle Corporation. With these embodiments, the information in the database may be arranged in tables, such that each record in the table includes a field denoting a user authorized to access the information contained in the record and a field denoting the replication locking state of the record. Thus, the value of the replication locking state field can be used to indicate that data cannot be inserted or modified in the record if the lock flag is set on any records in the table for a given buyer. As will be appreciated by those of ordinary skill in the art, the value of the replication locking state field may be “L” to indicate when a record is locked, and “U” when a record is unlocked. Also, corresponding tables are maintained on the remote device (e.g., the laptop or the personal digital assistant), to maintain the information during remote use of the Tool 200.

In order to copy a record for remote use, the Fact Based Negotiation Tool 200 first checks the database 220 to determine if the replication locking state field of the record is set to “unlocked” for the user. If the value of the replication locking state field indicates that the record is locked, then replication cannot proceed, as a replication is already outstanding. Next, the Tool 200 checks the database on the remote device, to determine if the replication locking state field of the record on the remote device is set to “locked.” If this record on the remote device is unlocked, then replication cannot proceed, as a replication is outstanding.

Next, the Tool 200 preferably verifies the integrity and structure of the remote database, and then deletes all of the user's records from the tables in the remote database. The Fact Based Negotiation Tool 200 causes the records from the database 220 to be copied into the remote database, and, upon success of the copy, sets the value of the replication locking state field for each of the copied records on the database 220 to locked, and sets the value of the replication locking state field for each of the copied records on the database. This prevents anyone else from modifying these records until the remote database is synchronized with the database 220.

In order to synchronize the remote database with the database 220, the Fact Based Negotiation Tool 200 first checks to confirm that the value of the replication locking state field for each of the copied records on the database 220 is set to “locked,” and that the value of the replication locking state field for each of the copied records on the database is set to “unlocked.” If either of these values is incorrect, then synchronization will not proceed. Next, the Tool 200 uses the information in the remote database to add new records to or modify existing records in the database 220. Preferably, the Tool 200 does not delete records from the database 220. Instead, this should preferably be required from the user when the user is connected to the database 220 via a network connection. Once the synchronization is complete, the Fact Based Negotiation Tool sets the value of the replication locking state field for each of the synchronized records on the database 220 to “unlocked,” and sets the value of the replication locking state field for each of the records on the remote database to “locked.” With this arrangement, the Fact Based Negotiation Tool 200 can ensure that a user can remotely view and manipulate cost information, product information and other information without creating discrepancies in the main database 220.

The present invention has been described above by way of specific exemplary embodiments, and the many features and advantages of the present invention are apparent from the written description. Thus, it is intended that the appended claims cover all such features and advantages of the invention. Further, because numerous modifications and changes will readily occur to those skilled in the art, the specification is not intended to limit the invention to the exact construction and operation as illustrated and described. For example, the invention may include any one or more elements from the apparatus and methods described herein in any combination or subcombination. Accordingly, there are any number of alternative combinations for defining the invention, which incorporate one or more elements from the specification (including the drawings, claims, and summary of the invention) in any combinations or subcombinations. Hence, all suitable modifications and equivalents may be considered as falling within the scope of the appended claims.

I/We claim:

1. A method of managing cost information by a fact based negotiation tool, comprising:
transmitting, to one or more suppliers, a request for product cost information for a product to be provided by the one or more suppliers;
receiving product cost information from the one or more suppliers;
electronically storing the product cost information from the one or more suppliers;
receiving a sales price for the product;
using the received sales price and the product cost information, calculating a profit margin for sale of the product if supplied by each of the one or more suppliers; and
displaying the calculated profit margins for sale of the product if supplied by each of the one or more suppliers.

2. The method of managing cost information by a fact based negotiation tool recited in claim 1, wherein
the request for product cost information is transmitted to each of a plurality of suppliers;
the product cost information is received from each of the plurality of suppliers;
the profit margin for sale of the product is calculated for each of the plurality of suppliers; and
the displayed profit margins for sale of the product includes the profit margin calculated for each of the plurality of suppliers.

3. The method of managing cost information by a fact based negotiation tool recited in claim 1, wherein
the request for product cost information is transmitted to the one or more suppliers by electronic mail; and
the product cost information is received from the one or more suppliers by electronic mail.

4. The method of managing cost information by a fact based negotiation tool recited in claim 1, further including obtaining the product cost information from the one or more suppliers by
providing a cost sheet listing cost components of the product to the one or more suppliers; and
receiving the cost sheet containing costs for the cost components from the one or more suppliers.

5. The method of managing cost information by a fact based negotiation tool recited in claim 4, further including
providing the cost sheet to the one or more suppliers by electronic mail;
receiving the cost sheet containing costs for the cost components from the one or more suppliers by electronic mail; and
importing the costs for the cost components from the received cost sheet.

6. The method of managing cost information by a fact based negotiation tool recited in claim 1, further including:
defining the product to be provided by one or more suppliers.

7. The method of managing cost information by a fact based negotiation tool recited in claim 1, further including graphically displaying the cost information from the one or more suppliers.

8. The method of managing cost information by a fact based negotiation tool recited in claim 7, further including graphically displaying the cost information for the product for each of the suppliers.

9. A method of managing cost information by a fact based negotiation tool, comprising:
defining a plurality of products to be provided by one or more suppliers;
obtaining, from one or more suppliers, cost information for purchase of each of the products from the one or more suppliers;
receiving a sales price for each of the products;
determining a profit margin for sales of each of the products if supplied by the one or more suppliers; and
simultaneously displaying for each of the products the determined profit margins.

10. The method of managing cost information by a fact based negotiation tool recited in claim 9, wherein
the cost information for purchase of each product is obtained from each of a plurality of suppliers associated with the product;
for each product, the profit margin of the product is determined if provided by each of the plurality of suppliers associated with the product; and
the displayed profit margins include determined profit margins for sales of each product for each of the plurality of suppliers associated the product.

11. The method of managing cost information by a fact based negotiation tool recited in claim 10, further including obtaining the cost information for each of the products from the one or more suppliers by
requesting the cost information for each product from each of the plurality of suppliers by electronic mail; and
receiving the cost information for each product from each of the plurality of suppliers by electronic mail.

12. The method of managing cost information by a fact based negotiation tool recited in claim 11, further including obtaining the cost information for the product from the one or more suppliers by
preparing a cost sheet for each product listing cost components of the product; and
providing the cost sheets to each of the plurality of suppliers to be completed with the cost information.

13. The method of managing cost information by a fact based negotiation tool recited in claim 12, where the cost sheet for one of the products includes different cost components than the cost sheet for another of the products.

14. The method of managing cost information by a fact based negotiation tool recited in claim 12, further including
preparing the cost sheet in an electronic format; and
providing the cost sheet to the one or more suppliers by electronic mail.

15. A method of managing cost information by a fact based negotiation tool, comprising:
defining a plurality of products for purchase, such that each product is associated with one or more suppliers that may provide the product;
obtaining cost information for purchase of each of the products from the one or more suppliers associated with product;
electronically storing the cost information for each of the products obtained from the one or more suppliers associated with the product; and
simultaneously displaying the cost information for two or more of the products.

16. The method of managing cost information by a fact based negotiation tool recited in claim 15, further including graphically displaying the cost information for each product.

17. The method of managing cost information by a fact based negotiation tool recited in claim 15, wherein
the cost information for at least one product is obtained from each of a plurality of suppliers associated with the at least one product; and
the simultaneously displayed cost information includes the cost information for the at least one product and each supplier associated with the at least one product.

18. The method of managing cost information by a fact based negotiation tool recited in claim 17, wherein the cost information for the at least one product is graphically displayed.

19. The method of managing cost information by a fact based negotiation tool recited in claim 15, further including obtaining the cost information for each of the products from the one or more suppliers by
requesting the cost information for each product from the one or more suppliers by electronic mail; and
receiving the cost information for each product from the one or more suppliers by electronic mail.

20. The method of managing cost information by a fact based negotiation tool recited in claim 15, further including obtaining the cost information for the product from the one or more suppliers by
preparing a cost sheet for each product listing cost components of the product; and
providing the cost sheets to the one or more suppliers to be completed with the cost information.

21. The method of managing cost information by a fact based negotiation tool recited in claim 20, wherein the cost sheet for one of the products includes different cost components than the cost sheet for another of the products.

22. The method of managing cost information by a fact based negotiation tool recited in claim 20, further including
preparing the cost sheet in an electronic format; and
providing the cost sheet to the one or more suppliers by electronic mail.

23. A fact based negotiation tool for providing information to help a user negotiate purchases, comprising:
a cost sheet preparation component for preparing and transmitting, to one or more suppliers, a request for product cost information for a product to be provided by the one or more suppliers;
a cost information import component that receives and electronically stores product cost information provided by the one or more suppliers in a database; and
a view cost sheets component that displays product cost information provided by one of the one or more suppliers.

24. The fact based negotiation tool recited in claim 23, further including a compare costing component that displays product cost information provided by two or more of the one or more suppliers can be displayed simultaneously.

25. The fact based negotiation tool recited in claim 23, further including an analyze margins component that receives a sales price for the product, uses the received sales price and the product cost information to calculate a profit margin for sale of the product if supplied by each of the one or more suppliers, and displays the calculated profit margins for sale of the product if supplied by each of the one or more suppliers.

26. The fact based negotiation tool recited in claim 25, further including a graph costs component that graphically displays the calculated profit margins and the product cost information provided by the one or more suppliers.

27. The fact based negotiation tool recited in claim 25, further including a graph costs component that graphically displays the product cost information provided by the one or more suppliers.

28. The fact based negotiation tool recited in claim 23, further including a database that stores product cost information provided by the one or more suppliers.

29. A computer-readable medium having computer-executable instructions for performing steps comprising:
transmitting, to one or more suppliers, a request for product cost information for a product to be provided by the one or more suppliers;
receiving product cost information from the one or more suppliers;
electronically storing the product cost information from the one or more suppliers;
receiving a sales price for the product;
using the received sales price and the product cost information, calculating a profit margin for sale of the product if supplied by each of the one or more suppliers; and
displaying the calculated profit margins for sale of the product if supplied by each of the one or more suppliers.

30. The computer-readable medium recited in claim 29, wherein the instructions provide that:
the request for product cost information is transmitted to each of a plurality of suppliers;
the product cost information is received from each of the plurality of suppliers;
the profit margin for sale of the product is calculated for each of the plurality of suppliers; and
the displayed profit margins for sale of the product includes the profit margin calculated for each of the plurality of suppliers.

31. The computer-readable medium recited in claim 29, wherein the instructions provide that:
the request for product cost information is transmitted to the one or more suppliers by electronic mail; and
the product cost information is received from the one or more suppliers by electronic mail.

32. The computer-readable medium recited in claim 29, wherein the instructions provide that the step of obtaining the product cost information from the one or more suppliers includes:
providing a cost sheet listing cost components of the product to the one or more suppliers; and
receiving the cost sheet containing costs for the cost components from the one or more suppliers.

33. The computer-readable medium recited in claim 32, further including instructions for performing the steps of:
providing the cost sheet to the one or more suppliers by electronic mail;
receiving the cost sheet containing costs for the cost components from the one or more suppliers by electronic mail; and
importing the costs for the cost components from the received cost sheet.

34. The computer-readable medium recited in claim 29, further including instructions for performing the step of defining the product to be provided by one or more suppliers.

35. The computer-readable medium recited in claim 29, further including instructions for performing the step of graphically displaying the cost information from the one or more suppliers.

36. The computer-readable medium recited in claim 29, further including instructions for performing the step of graphically displaying the cost information for the product for each of the suppliers.
